(19) United States
(12) Patent Application Publication
(10) Pub. No.: US 2012/0191897 A1
(43) Pub. Date: Jul. 26, 2012

(54) NON-VOLATILE MEMORY SYSTEM AND MANAGEMENT METHOD THEREOF

(75) Inventors: Wun Mo YANG, Ichon-si (KR); Kyeong Rho Kim, Ichon-si (KR); Jeong Soon Kwak, Ichon-si (KR)

(73) Assignee: Hynix Semiconductor Inc., Ichon-si (KR)

(21) Appl. No.: 13/188,668

(22) Filed: Jul. 22, 2011

(30) Foreign Application Priority Data
Jan. 21, 2011 (KR) 10-2011-0006222

(51) Int. Cl. G06F 12/02

(52) U.S. Cl. 711/103; 711/E12.008

(57) ABSTRACT

A non-volatile memory system includes a memory area including a plurality of non-volatile memory blocks, and a micro control unit configured to manage the memory blocks as a data block and a buffer block. As a write command is input, if no buffer block assigned to the data block exists and a free page exists in the data block, the micro control unit converts the data block to a self-buffer block.

### CROSS-REFERENCE TO RELATED APPLICATION

The present application claims priority under 35 U.S.C. §119(a) to Korean Patent Application No. 10-2011-0006222, filed on Jan. 21, 2011, in the Korean Intellectual Property Office, which is incorporated herein by reference in its entirety as if set forth in full.

### BACKGROUND

1. Technical Field

Various embodiments of the present invention relates to a semiconductor memory apparatuses and related methods. In particular, certain embodiments relate to a non-volatile memory is system and a management method thereof.

2. Related Art

The low power consumption and high resistance against shock of non-volatile memories such as a flash memory have led to a small sized fabrication and, thus extensive use of such non-volatile memories in mobile multimedia products.

However, flash memories have disadvantages in that an erase operation should be performed prior to a data write operation and a unit area (a block) of the erase operation is significantly larger than a unit area (a page) of a data read/write operation.

Therefore, in order to update data stored in a specific page of the flash memory, content of other pages as well as content of the page to be updated should be erased. In this regard, a block mapping scheme, a page mapping scheme, or a hybrid mapping scheme which is a mixture of the former two schemes, has been used.

The block mapping scheme works as follows: in response to generation of a data write command, a new block is chosen, pages other than the page to be updated in the original block are copied into the new bock, data in the page to be updated is recorded on the new bock, a block-wise mapping table is modified such that the original block is replaced with the new block, and the original block is erased.

According to the page mapping scheme, data in a logical page to be updated is recorded on a random empty physical page, and page-wise mapping information on the corresponding logical is page is modified to point the physical page storing updated data.

According to the hybrid mapping scheme, meta data of a file system with a high update frequency is managed using the page mapping scheme whereas user data with a low update frequency is managed using the block mapping scheme.

When using the block mapping scheme, the mapping to the new block has to be changed whenever a data write operation is performed and thus the modified data and other data included in the corresponding block should be copied, which is called a consolidation operation. In order to solve such a problem, a log buffer-based block management scheme has been introduced.

A log buffer-based flash memory system uses a part of a plurality of blocks constituting a flash memory as log blocks. Each log block is mapped to one data block, and is configured to temporarily store data which will be ultimately written into the corresponding data block.

When a new write command for a specific data block is generated and a free page exists in the log block mapped to the corresponding data block, the data is stored in the free page of the log block.

Meanwhile, if there is no log block mapped to the corresponding data block or there is no free page in the log block mapped to the corresponding data block, one of the log blocks mapped to other data blocks is selected as a sacrifice block, and content of the selected sacrifice block is copied into the data block. Then, data in the sacrifice block is erased.

When the log blocks are used, the consolidation operation may be prohibited from being performed whenever the data write operation is performed. Therefore, data can be processed at a high speed.

As described above, in the flash memory system using the log blocks, data to be written is always written in one of the log blocks first. Thus, if all log blocks mapped to data blocks are in use or there is no log block mapped to the data block, a log block need to be secured to write data by performing a block replacement algorithm.

Performing the block replacement algorithm accompanies performing data copy, erase and address mapping processes. This may deteriorate the operation efficiency of a flash memory apparatus, and frequent data copy and erase may reduce the lifespan of the flash memory.

### SUMMARY

Accordingly, there is a need for an improved flash memory system that is equipped with an efficient block replacement algorithm.

To attain the advantages and in accordance with the purposes of the invention, as embodied and broadly described herein, one exemplary aspect of the present invention may provide a non-volatile memory system that includes: a memory area including a plurality of non-volatile memory blocks; and a micro control unit configured to manage the memory blocks as a data block and a is buffer block, wherein, as a write command is input, if no buffer block assigned to the data block exists and a free page exists in the data block, the micro control unit converts the data block to a self-buffer block.

In another exemplary aspect of the present invention, a method of managing a non-volatile memory system including a memory area and a micro control unit that separately manages the memory area as a data block and a log block may comprise: as a write command is input, checking by the micro control unit whether the log block has been assigned to the data block; if the log block has not been assigned, checking by the micro control unit whether a free page exists in the data block; and if the free page exists, converting by the micro control unit the data block to a self-buffer block.

In still another exemplary aspect of the present invention, a method of managing a non-volatile memory system including a memory area and a micro control unit that separately manages the memory area as a data block and a log block may comprise: as a reading command is input, checking by the micro control unit whether a log block assigned to the data block is a self-buffer block; and if the self-buffer block has been assigned to the data block, outputting valid data from the self-buffer block under a control of the micro control unit.

In still another exemplary aspect of the present invention, a non-volatile memory system comprising: a memory area including a plurality of non-volatile memory blocks; and a micro control unit is configured to manage the memory blocks as a data block and a buffer block, and to store an address mapping table and update the address mapping table when converting the data block to the self-buffer block; wherein, as a read command is input, if a log block assigned to the data block is a self-buffer block, the micro control unit reads data from a corresponding page of the self-buffer blocks.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various embodiments consistent with the invention and, together with the description, serve to explain the principles of the invention.

FIG. 1 is a configuration diagram of a non-volatile memory system according to an embodiment;

FIG. 2 is a configuration diagram of an address mapping table applied to the invention;

FIG. 3 is a diagram explaining a log block management concept in a non-volatile memory system of the invention; and

FIGS. 4 and 5 are flowcharts explaining a method of managing a non-volatile memory according to an embodiment; and

FIG. 6 is a flowchart explaining a method of managing a non-volatile memory according to another embodiment.

### DETAILED DESCRIPTION

Reference will now be made in detail to the exemplary embodiments consistent with the present disclosure, examples of which are illustrated in the accompanying drawings. Wherever possible, the same reference characters will be used throughout the drawings to refer to the same or like parts.

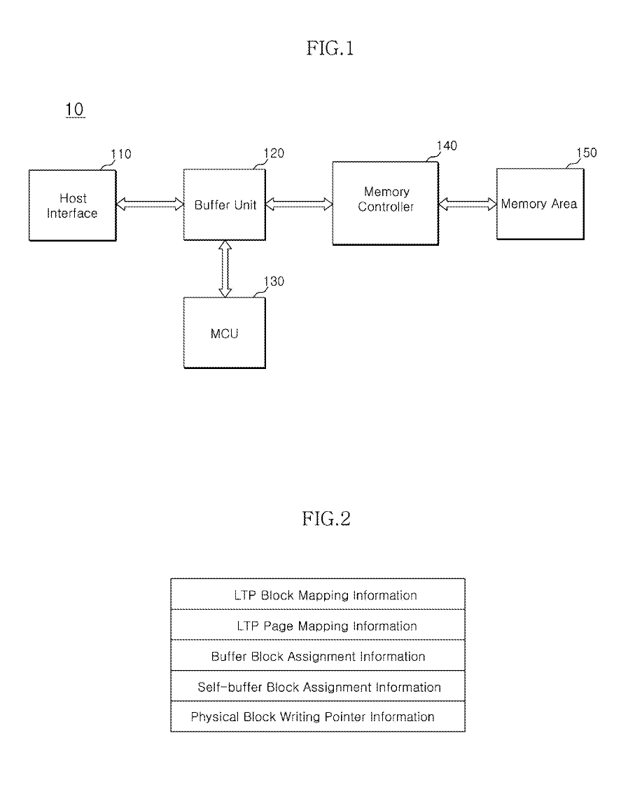

FIG. 1 is a configuration diagram of a non-volatile memory system according to an embodiment of the present invention.

As illustrated in FIG. 1, a non-volatile memory system 10 according to the embodiment may include a host interface 110, a buffer unit 120, a micro control unit (MCU) 130, a memory controller 140, and a memory area 150.

The host interface 110 is configured to be connected to the buffer unit 120 and transmit/receive a control command, an address signal and a data signal between an external host (not shown) and the non-volatile memory system 10.

The buffer unit 120 is configured to buffer signals or data output from the host interface 110, or buffer data transmitted from is the memory area 150. Furthermore, it is possible for the buffer unit 120 to buffer an output signal from the MCU 130 and provide a buffered signal to the host interface 110 and the memory controller 140.

The MCU 130 is configured to transmit/receive the control command, the address signal and the data signal to/from the host interface 110 through the buffer unit 120, or control the memory controller 140 using these signals.

In addition, the MCU 130 may include a file system and software “flash translation layer” (FTL). The file system may perform a file and directory management function and the like in order to provide users with a more efficient storage environment. The FTL allows the memory area 150 to be used as a virtual block device and performs an address mapping function therefor. That is, the FTL converts a logical address transferred from an application into a physical address used in the memory area 150. The MCU 130 performs a block replacement function using the address mapping table of the FTL.

The memory controller 140 is configured to select a predetermined memory device from a plurality of non-volatile memory devices provided in the memory area 150, and provide write, erase and read commands. Furthermore, the memory controller 140 is configured to temporarily store meta data, such as mapping information between a logical address and a physical address, as reference information on an operation in progress through a buffer is (not shown) provided therein.

Data write, erase and read operations are performed for the memory area 150 under the control of the memory controller 140. The non-volatile memory device constituting the memory area 150 includes a plurality of blocks, and at least a part of the plurality of blocks are designated as log blocks and mapped to other blocks, that is, data blocks. Thus, in a write operation, data is not directly written to the data block but is first written to the relevant log block.

In this regard, a log block may be called a buffer block. In addition, a self-buffer block, which will be described later, is a storage space used by converting a data block to a buffer block. In the exemplary embodiment, it should be understood that the log blocks include the buffer blocks, and the self-buffer blocks which are converted from the data block.

In the write operation of the non-volatile memory system 10, if no log block (no buffer bock or no self-buffer block) is assigned to the corresponding data block, the MCU 130 according to the exemplary embodiment checks whether a free page exists in the corresponding data block. If a free page exists, the MCU 130 converts the corresponding data block to a self-buffer block. Thus, data transmitted from a host is stored in the free page of the converted self-buffer.

If a log block has been assigned to the accessed data block, the MCU 130 checks whether a free page exists in the assigned log block. If a free page exists, the MCU 130 writes data into the free page. Meanwhile, if a log block has been assigned to the accessed data block but no free page exists, the MCU 130 secures a new log block by applying the block replacement algorithm based on whether the log block assigned to the corresponding data block is a buffer block or a self-buffer block, and writes data into the new log block.

FIG. 2 is a configuration diagram of an address mapping table which is applicable to an exemplary embodiment of the invention.

According to the exemplary embodiment, if a log block has not been assigned to the accessed data block for a write operation but a free page exists, the corresponding data block is converted into a self-buffer block. Afterwards, the address of the block, which is converted to a self-buffer block, should be managed.

FIG. 2 illustrates an example of an address mapping table managed by the MCU 130, and the address mapping table may include logical-physical (LTP) block mapping information, LTP page mapping information, buffer block assignment information, and self-buffer block assignment information.

If a data block is converted to the self-buffer block, the LTP block mapping information and the self-buffer block assignment information, which have been modified according to the conversion, are updated.

At this time, the LTP page mapping information of the self-buffer block does not need to be stored in the address mapping table every time the LTP page mapping information is modified. The logical is page address of the self-buffer block may be stored in a corresponding page of the self-buffer block, and the LTP page mapping information can be maintained in the memory controller 140 only. When the system is powered off and then is turned on, pages of self-buffer blocks are scanned to check logical addresses, and the LTP page mapping information maintained in the memory controller 140 is updated.

Meanwhile, the address mapping table according to the exemplary embodiment may further include physical block write pointer information. This indicates the boundary to which data has been written in a physical page of a data block, and may be a reference for checking whether a free page exists in the data block accessed in a write operation.

FIG. 3 is a diagram illustrating a log block management concept in the non-volatile memory system according to an exemplary embodiment.

A data block accessed for a write operation may include pages A on which data has been already written and free pages B.

If a log block has not been assigned to such data block, the MCU 130 of the exemplary embodiment converts the corresponding data block to a self-buffer block. It goes without saying that the information on the address mapping table shown in FIG. 2 is changed according to such block change.

In addition, data transmitted from the host is stored in a free page of the converted self-buffer block.

In the non-volatile memory system using the log block, data is stored in the log bock once. Thus, if there is no log block mapped to the accessed data block, a sacrifice log block is selected and information on the selected sacrifice log block is copied into the data block. Then, the selected sacrifice log block is erased and mapped to the accessed data block, resulting in the storage of data.

However, according to an exemplary embodiment, if there is no log block mapped to the accessed data block, it is checked whether any free page exists in the accessed data block. If a free page exists, the data block is converted to a self-buffer block and data is recorded thereon.

Consequently, it is possible to write data without performing a consolidation operation including data copy and erase, address mapping and the like. As a result, the operation speed of the non-volatile memory system is increased, so that the performance of the system can be improved.

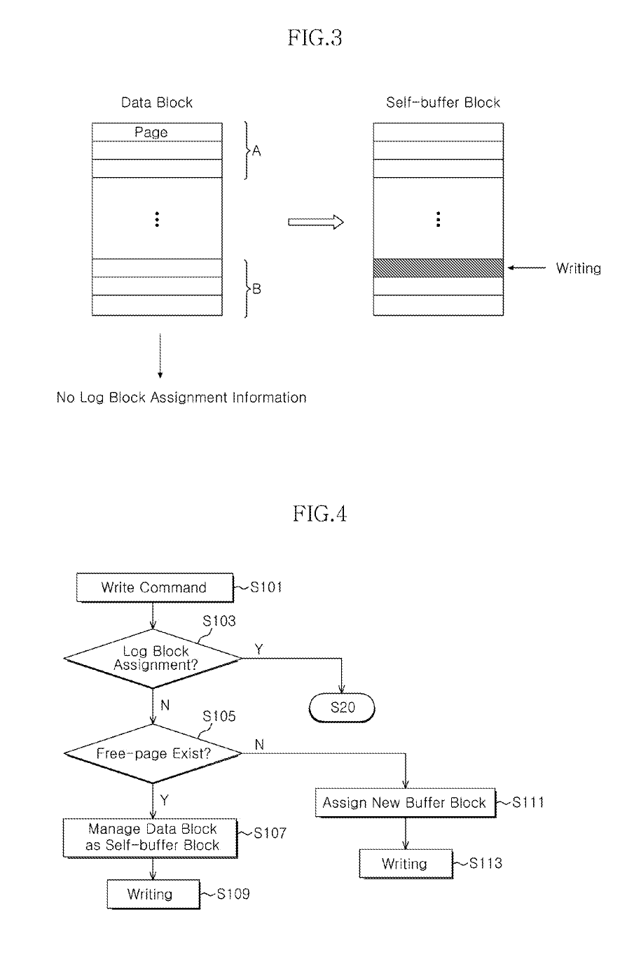

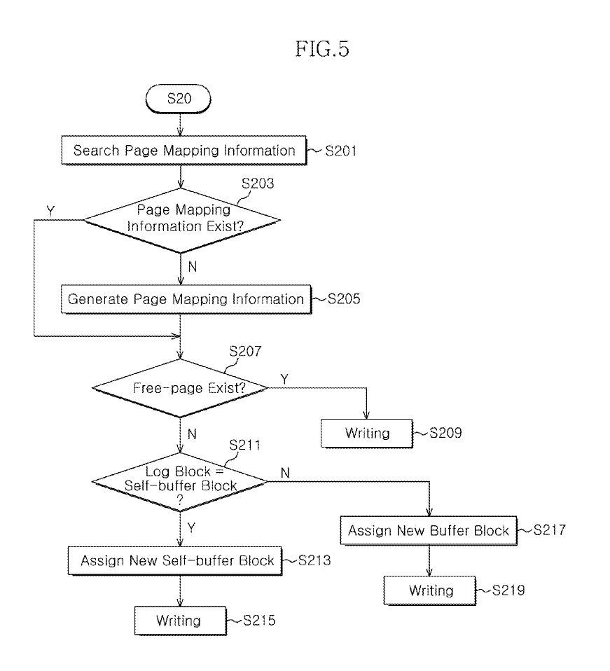

FIGS. 4 and 5 are flowcharts explaining a method of managing the non-volatile memory according to the exemplary embodiment, and illustrate a data write operation.

As a write command is input from the host (S101), the MCU 130 checks whether a log block (a buffer block or a self-buffer block) has been assigned to the data block accessed for write with reference to the address mapping table (S103).

As a result of the check in S103, if a log block has not been assigned, the MCU 130 checks whether a free page exists in the is accessed data block (S105). The MCU 130 may refer to the physical block write pointer information in the address mapping table.

If a free page exists, the MCU 130 administers the corresponding data block as a self-buffer block (S107). That is, the MCU 130 stores LTP block mapping information based on the designation of the corresponding data block as the self-buffer block in the address mapping table.

Then, the memory controller 140 writes data on the converted self-buffer block (S109). At this time, a logical page address of the self-buffer block on which the data is recorded is also stored, and the LTP page mapping information is updated by the memory controller 140.

As a result of the check in S105, if there is no free page, the MCU 130 assigns a new buffer block (S111) and the memory controller 140 writes data on the new buffer block (S113). The new buffer block may be assigned using a typical block replacement algorithm. That is, one of the buffer blocks is selected as a sacrifice buffer block and data of the sacrifice buffer block is copied into a new data block. Then, the sacrifice buffer block is erased. The sacrifice buffer block may be selected using a least recently used (LRU) scheme. However, the invention is not limited thereto. For example, it may be possible to use a round robin scheme that selects the earliest assigned buffer block as the sacrifice buffer block. In the data write (S113), the logical page address of the buffer block on which the data is written is also stored, and the LTP page mapping is information is updated by the memory controller 140.

If the log block has been assigned to the data block accessed for writing in step S103 of FIG. 4, the procedure shown in FIG. 5 is performed.

The MCU 130 accesses the memory controller 140 to search for LTP page mapping information on the log block (the buffer block or the self-buffer block) assigned to the corresponding data block (S201).

If the LTP page mapping information has not been maintained in the memory controller 140 (S203), the MCU 130 scans the corresponding log block to generate LTP page mapping information (S205).

The MCU 130 checks whether a free page exists in the corresponding log block (S207). The MCU 130 may refer to the physical block write pointer information on the address mapping table.

As a result of the check in S207, if a free page exists, the MCU 130 writes data on the corresponding free page under the control of the memory controller 140 (S209). Meanwhile, if no free page exists, the MCU 130 checks whether the log block assigned to the corresponding data block is a self-buffer bock (S211). If the log block is a self-buffer bock, the MCU 130 assigns a new self-buffer bock though the block replacement algorithm for the self-buffer bock and writes data (S213 and S215).

If the log block is a buffer block, the MCU 130 also assigns a new buffer bock though the block replacement algorithm for the is buffer bock and writes data (S217 and S219).

Regardless of whether the log block is a self-buffer bock or a buffer bock, the block replacement algorithm may be applied as one of applicable algorithms. For example, one of the log blocks is selected as a sacrifice log block and data of the sacrifice log block is copied into a new data block. Then, the sacrifice log block is erased, data of the accessed data block is copied into the sacrifice log block, and information on the accessed data block is erased. The sacrifice buffer block may be selected using the least recently used (LRU) scheme. However, the invention is not limited thereto. For example, it may be possible to use the round robin scheme that selects the earliest assigned buffer block as the sacrifice buffer block.

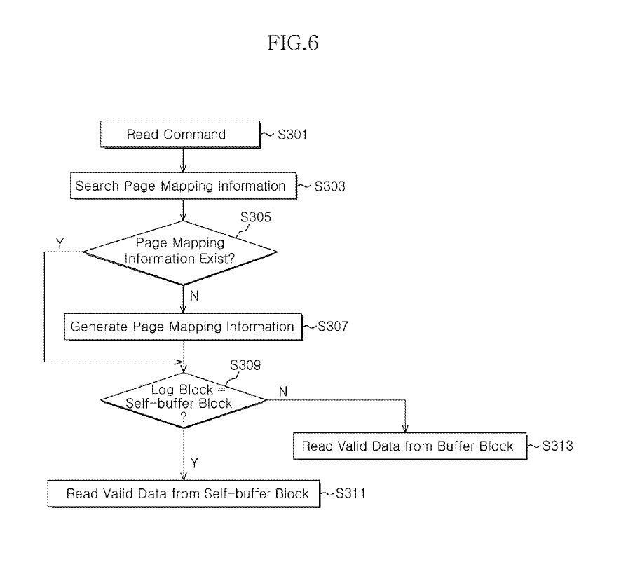

FIG. 6 is a flowchart explaining a method of managing the non-volatile memory according to another exemplary embodiment, and illustrates a data read operation.

As a read command is input from the host (S301), the MCU 130 accesses the memory controller 140 to search for LTP page mapping information on the log block (a buffer block or a self-buffer block) assigned to the corresponding data block (S303).

If the LTP page mapping information has not been maintained in the memory controller 140 (S305), the MCU 130 scans the corresponding log block to generate LTP page mapping information (S307).

The MCU 130 checks whether the log block assigned to the corresponding data block is a self-buffer block (S309). If valid data is has been written on a corresponding page of the corresponding self-buffer block, the memory controller 140 reads the valid data (S311).

If the log block assigned to the corresponding data block is a buffer block, the memory controller 140 also reads valid information recorded on the corresponding page of the corresponding buffer block (S313).

If the valid data has not been recorded on the log block, the memory controller 140 may output an error message to the host.

In the exemplary embodiment, if a log block has not been assigned to a data block accessed according to a write command, it is checked whether the corresponding data block has a free page. If a free page exists, the corresponding data block is managed as a self-buffer block and data is written.

Thus, if a log block has not been assigned but the data block has a free page, data can be written without performing the consolidation operation, resulting in an improvement of the performance of the system.

In order to perform such an operation, the presence or absence of a free page is checked using the physical block write pointer information. Furthermore, LTP page mapping information on a block converted to a self-buffer block does not need to be stored in a memory area every time the LTP page mapping information is modified. That is, logical page information is also stored when data is stored in the self-buffer block, and the logical page information on the self-buffer block is scanned when an access to the self-buffer is block is generated, so that it is possible to maintain the latest LTP page mapping information.

While certain embodiments have been described above, it will be understood to those skilled in the art that the embodiments described are by way of example only. Accordingly, a non-volatile memory system and a management method thereof described herein should not be limited based on the described embodiments. Rather, the non-volatile memory system and the management method thereof described herein should only be limited in light of the claims that follow when taken in conjunction with the above description and accompanying drawings.

What is claimed is:

1. A non-volatile memory system comprising:
a memory area including a plurality of non-volatile memory blocks; and
a micro control unit configured to manage the memory blocks as a data block and a buffer block,
wherein, as a write command is input, if no buffer block assigned to the data block exists and a free page exists in the data block, the micro control unit converts the data block to a self-buffer block.

2. The non-volatile memory system according to claim 1, wherein the micro control unit is configured to store an address is mapping table and update the address mapping table when converting the data block to the self-buffer block.

3. The non-volatile memory system according to claim 1, wherein the micro control unit is configured to store physical block write pointer information and check whether the free page exists in the data block with reference to the physical block write pointer information.

4. The non-volatile memory system according to claim 1, wherein, as a write or read command is input, if a log block has been assigned to the data block, the micro control unit generates logical-physical page mapping information on the log block.

5. The non-volatile memory system according to claim 4, wherein, as the write command is input, if the log block has been assigned to the data block, the micro control unit checks whether the free page exists in the log block.

6. The non-volatile memory system according to claim 1, further comprising:
a memory controller that records data and a logical page address on the self-buffer block under a control of the micro control unit as the write command is input.

7. A method of managing a non-volatile memory system including a memory area and a micro control unit that separately manages the memory area as a data block and a log block, comprising:
as a write command is input, checking by the micro control unit whether the log block has been assigned to the data block;
if the log block has not been assigned, checking by the micro control unit whether a free page exists in the data block; and
if the free page exists, converting by the micro control unit the data block to a self-buffer block.

8. The method according to claim 7, further comprising:
storing data and a logical page address in the self-buffer block.

9. The method according to claim 7, further comprising:
if the log block has been assigned, checking by the micro control unit whether the free page exists in the assigned log block; and
if the free page exists in the assigned log block, write data under a control of the micro control unit.

10. The method according to claim 9, wherein writing the data further comprises:
storing a logical page address.

11. The method according to claim 10, further comprising:
if the log block has been assigned, checking by the micro control unit whether logical-physical page mapping information on the log block exists; and
if the logical-physical page mapping information does not exist, scanning by the micro control unit the logical page address of the log block to generate the logical-physical page mapping information.

12. The method according to claim 8, further comprising:
if the free page does not exist in the assigned log block, checking by the micro control unit whether the log block is a self-buffer block; and
if the log block is the self-buffer block, performing by the micro control unit a block conversion algorithm with respect to the self-buffer block.

13. The method according to claim 12, further comprising:
if the log block is a buffer block, performing by the micro control unit the block conversion algorithm with respect to the buffer block.

14. The method according to claim 7, further comprising:
if the free page do not exist, performing by the micro control unit a block conversion algorithm with respect to a buffer block.

15. A method of managing a non-volatile memory system including a memory area and a micro control unit that separately manages the memory area as a data block and a log block, comprising:
as a reading command is input, checking by the micro control unit whether a log block assigned to the data block is a self-buffer block; and
if the self-buffer block has been assigned to the data block, outputting valid data from the self-buffer block under a control of the micro control unit.

16. The method according to claim 15, further comprising:
if a buffer block has been assigned to the data block, outputting valid data from the buffer block under the control of the micro control unit.

17. The method according to claim 15, further comprising:
as the reading command is input, checking by the micro control unit whether logical-physical page mapping information on the log block assigned to the data block exists; and
if the logical-physical page mapping information does not exist, scanning by the micro control unit the log block to generate the logical-physical page mapping information.

18. A non-volatile memory system comprising:
is a memory area including a plurality of non-volatile memory blocks; and
a micro control unit configured to manage the memory blocks as a data block and a buffer block, and to store an address mapping table and update the address mapping table when converting the data block to the self-buffer block;
wherein, as a read command is input, if a log block assigned to the data block is a self-buffer block, the micro control unit reads data from a corresponding page of the self-buffer block.

19. The non-volatile memory system according to claim 18, if a log block assigned to the data block is a buffer block, the micro control unit reads data from a corresponding page of the buffer block.
